(19) United States
(12) Patent Application Publication
(10) Pub. No.: US 2024/0064830 A1
(43) Pub. Date: Feb. 22, 2024

(54) PROVIDING CONFIGURATION INFORMATION FOR ACCESSING A STANDALONE NON-PUBLIC NETWORK

(71) Applicant: QUALCOMM Incorporated, San Diego, CA (US)

(72) Inventors: Sebastian SPEICHER, Wallisellen (CH); Haris ZISIMOPOULOS, London (GB)

(21) Appl. No.: 18/259,362

(22) PCT Filed: Feb. 17, 2022
(86) PCT No.: PCT/US2022/070701

§ 371 Date: Jun. 26, 2023

(30) Foreign Application Priority Data
Feb. 17, 2021 (GR) 20210100100

(51) Int. Cl. H04W 76/12

(52) U.S. Cl. CPC H04W 76/12; H04W 80/02

(57) ABSTRACT

Techniques described herein enable the provision of configuration information between one or more network entities of a home service provider (SP) and one or more network entities of a network such as a standalone non-public network (SNPN) to support a user equipment (UE) associated with the home SP that is visiting the SNPN. For example, the configuration information may enable the UE to access or use services provided by the home SP. In some aspects, the configuration information may include a proxy call session control function address, tunneling information, or the like. In this way, functions are supported for a UE visiting an SNPN despite a home SP that provides the functions not having a session management function (SMF) for signaling of configuration information supporting the functions. Thus, the interconnection of SNPNs and home SP networks is improved.

### CROSS-REFERENCE TO RELATED APPLICATION

This patent application claims priority to Greece Patent Application No. 20210100100, filed on Feb. 17, 2021, entitled “PROVIDING CONFIGURATION INFORMATION FOR ACCESSING A STANDALONE NON-PUBLIC NETWORK,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for providing configuration information for accessing a standalone non-public network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a 5G BS, a 5G Node B, or the like.

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the 3GPP. 5G is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

### SUMMARY

A standalone non-public network (SNPN) may provide radio access connectivity for user equipment (UEs) utilizing a radio access technology such as 5G. SNPNs may be useful in various applications, such as industrial automation (e.g., Industrial Internet of Things), public venues, public transportation, and so on.

A UE may be associated with a home service provider (SP). A home SP may include an SNPN operator, a public land mobile network (PLMN) operator, a credential provider (such as an entity that operates an authentication, authorization, and accounting (AAA) server without radio access functionality), or the like.

In some cases, a UE may access an SNPN using a credential provided by a home SP of the UE, despite the SNPN not being associated with (e.g., provided by) the home SP. A UE accessing an SNPN that is not provided by a home SP of the UE is referred to herein as visiting the SNPN. A communication protocol may provide for the authentication of the UE by an AAA server of the home SP (e.g., via the SNPN), or by one or more network entities of the home SP, such as an authentication server function (AUSF), a unified data management (UDM) function, or the like. However, some forms of configuration information may be handled by a session management function (SMF) of a given 5G system (5GS), such as an SNPN. If the home SP of a UE does not have an SMF, then signaling of such forms of configuration information, for the purpose of visiting an SNPN not associated with the home SP, may be hampered. Examples of such configuration information include a proxy call session control function (P-CSCF) address for a P-CSCF of the home SP, and tunneling information used to connect to an IP multimedia subsystem (IMS) of the home SP. If such forms of configuration information cannot be signaled to a UE visiting an SNPN, the UE may be unable to access IMS services provided by the home SP.

Some techniques and apparatuses described herein enable the provision of configuration information between one or more network entities of a home SP and one or more network entities of an SNPN to support a UE associated with the home SP that is visiting the SNPN. For example, the configuration information may enable the UE to access or use IMS services provided by the home SP. In some aspects, the configuration information may include a P-CSCF address, tunneling information, or the like. In some aspects, the configuration information may be provided by an AAA server of the home SP to an AAA proxy or another function in the SNPN, and the AAA proxy may forward the configuration information to an SMF which may signal the configuration information to a UE or to a user plane function (UPF) associated with the UE. In some aspects, the configuration information may be provided from a UDM of the home SP to the SMF, and the SMF may signal the configuration information to a UE or to a UPF associated with the UE. In this way, IMS functions are supported for a UE visiting an SNPN despite a home SP that provides the IMS functions not having an SMF for signaling of configuration information supporting the IMS functions. Thus, interconnection of SNPNs and home SP networks is improved.

In some aspects, a method of wireless communication performed by a first network entity includes identifying a protocol data unit (PDU) session with a UE; obtaining, based at least in part on identifying the PDU session, configuration information associated with a first service provider, wherein the first network entity is associated with a standalone non-public network provided by a second service provider; and transmitting the configuration information to the UE or to a second network entity associated with the standalone non-public network.

In some aspects, a method of wireless communication performed by a first network entity includes receiving, from a second network entity, a request for configuration information associated with a first service provider, wherein the first network entity and the second network entity are associated with a standalone non-public network provided by a second service provider, and wherein the configuration information relates to a UE associated with the first service provider accessing the standalone non-public network; obtaining the configuration information from a proxy entity associated with the standalone non-public network based at least in part on the request for the configuration information; and transmitting the configuration information to the second network entity.

In some aspects, a method of wireless communication performed by a first network entity includes receiving, from a network entity associated with a first service provider, configuration information relating to a UE accessing a standalone non-public network associated with the first network entity, wherein the standalone non-public network is associated with a second service provider; receiving, from a second network entity associated with the standalone non-public network, a request for at least part of the configuration information; and transmitting the configuration information to the second network entity based at least in part on the request.

In some aspects, a first network entity for wireless communication includes a memory and one or more processors coupled to the memory, the one or more processors configured to: identify a PDU session with a UE; obtain, based at least in part on identifying the PDU session, configuration information associated with a first service provider, wherein the first network entity is associated with a standalone non-public network provided by a second service provider; and transmit the configuration information to the UE or to a second network entity associated with the standalone non-public network.

In some aspects, a first network entity for wireless communication includes a memory and one or more processors coupled to the memory, the one or more processors configured to: receive, from a second network entity, a request for configuration information associated with a first service provider, wherein the first network entity and the second network entity are associated with a standalone non-public network provided by a second service provider, and wherein the configuration information relates to a UE associated with the first service provider accessing the standalone non-public network; obtain the configuration information from a proxy entity associated with the standalone non-public network based at least in part on the request for the configuration information; and transmit the configuration information to the second network entity.

In some aspects, a first network entity for wireless communication includes a memory and one or more processors coupled to the memory, the one or more processors configured to: receive, from a network entity associated with a first service provider, configuration information relating to a UE accessing a standalone non-public network associated with the first network entity, wherein the standalone non-public network is associated with a second service provider; receive, from a second network entity associated with the standalone non-public network, a request for at least part of the configuration information; and transmit the configuration information to the second network entity based at least in part on the request.

In some aspects, a non-transitory computer-readable medium storing a set of instructions for wireless communication includes one or more instructions that, when executed by one or more processors of a first network entity, cause the first network entity to: identify a PDU session with a UE; obtain, based at least in part on identifying the PDU session, configuration information associated with a first service provider, wherein the first network entity is associated with a standalone non-public network provided by a second service provider; and transmit the configuration information to the UE or to a second network entity associated with the standalone non-public network.

In some aspects, a non-transitory computer-readable medium storing a set of instructions for wireless communication includes one or more instructions that, when executed by one or more processors of a first network entity, cause the first network entity to: receive, from a second network entity, a request for configuration information associated with a first service provider, wherein the first network entity and the second network entity are associated with a standalone non-public network provided by a second service provider, and wherein the configuration information relates to a UE associated with the first service provider accessing the standalone non-public network; obtain the configuration information from a proxy entity associated with the standalone non-public network based at least in part on the request for the configuration information; and transmit the configuration information to the second network entity.

In some aspects, a non-transitory computer-readable medium storing a set of instructions for wireless communication includes one or more instructions that, when executed by one or more processors of a first network entity, cause the first network entity to: receive, from a network entity associated with a first service provider, configuration information relating to a UE accessing a standalone non-public network associated with the first network entity, wherein the standalone non-public network is associated with a second service provider; receive, from a second network entity associated with the standalone non-public network, a request for at least part of the configuration information; and transmit the configuration information to the second network entity based at least in part on the request.

In some aspects, an apparatus for wireless communication includes means for identifying a PDU session with a UE; means for obtaining, based at least in part on identifying the PDU session, configuration information associated with a first service provider, wherein the first network entity is associated with a standalone non-public network provided by a second service provider; and means for transmitting the configuration information to the UE or to a second network entity associated with the standalone non-public network.

In some aspects, an apparatus for wireless communication includes means for receiving, from a second network entity, a request for configuration information associated with a first service provider, wherein the first network entity and the second network entity are associated with a standalone non-public network provided by a second service provider, and wherein the configuration information relates to a UE associated with the first service provider accessing the standalone non-public network; means for obtaining the configuration information from a proxy entity associated with the standalone non-public network based at least in part on the request for the configuration information; and means for transmitting the configuration information to the second network entity.

In some aspects, an apparatus for wireless communication includes means for receiving, from a network entity associated with a first service provider, configuration information relating to a UE accessing a standalone non-public network associated with the first network entity, wherein the standalone non-public network is associated with a second service provider; means for receiving, from a second network entity associated with the standalone non-public network, a request for at least part of the configuration information; and means for transmitting the configuration information to the second network entity based at least in part on the request.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a UE in a wireless network.

FIG. 3 is a diagram of an example environment of a standalone non-public network (SNPN) and a network associated with a home service provider (SP) of a UE.

FIG. 4 is a diagram of an example environment of an SNPN and a network associated with a home SP of a UE, in accordance with the present disclosure.

FIGS. 5-8 are diagrams illustrating examples of provision of configuration information from a home SP for a UE accessing an SNPN.

FIGS. 9-11 are flowcharts of example methods of wireless communication.

FIG. 12 is a block diagram of an example apparatus for wireless communication.

FIG. 13 is a diagram illustrating an example of a hardware implementation for an apparatus employing a processing system.

FIG. 14 is a block diagram of an example apparatus for wireless communication.

FIG. 15 is a diagram illustrating an example of a hardware implementation for an apparatus employing a processing system.

FIG. 16 is a block diagram of an example apparatus for wireless communication.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

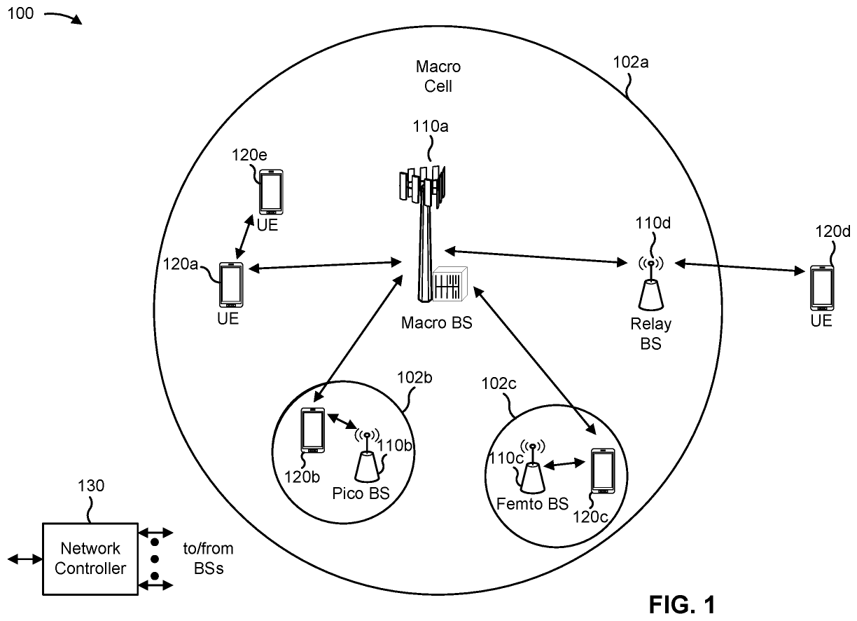

FIG. 1 is a diagram illustrating a wireless network 100 in which aspects of the present disclosure may be practiced. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as a 5G BS, a Node B, a gNB, a 5G NB, an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, or the like.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, radio access may be provided using an open radio access network (O-RAN) architecture. The O-RAN architecture may include a control unit (CU) that communicates with a core network via a backhaul link. Furthermore, the CU may communicate with one or more distributed units (DUs) via respective midhaul links. The DUs may each communicate with one or more radio units (RUs) via respective fronthaul links, and the RUs may each communicate with respective UEs via radio frequency (RF) access links. The DUs and the RUs may also be referred to as O-RAN DUs (O-DUs) and O-RAN RUs (O-RUs), respectively.

In some aspects, the DUs and the RUs may be implemented according to a functional split architecture in which functionality of a base station 110 (e.g., an eNB or a gNB) is provided by a DU and one or more RUs that communicate over a fronthaul link. Accordingly, as described herein, a base station 110 may include a DU and one or more RUs that may be co-located or geographically distributed. In some aspects, the DU and the associated RU(s) may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU may correspond to a logical unit that includes one or more base station functions to control the operation of one or more RUs. For example, in some aspects, the DU may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU. The RU(s) controlled by a DU may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) handle all over the air (OTA) communication with a UE 120, and real-time and non-real-time aspects of control and user plane communication with the RU(s) are controlled by the corresponding DU, which enables the DU(s) and the CU to be implemented in a cloud-based RAN architecture. Other examples of functional splits may be implemented.

In some aspects, one or more of the CU, the DU, or the RU may perform operations described herein as being performed by a network node. For example, one or more of the CU, the DU, or the RU may include a communication manager, as described above.

As indicated above, FIG. 1 is provided as an example. Other examples may differ from what is described with regard to FIG. 1.

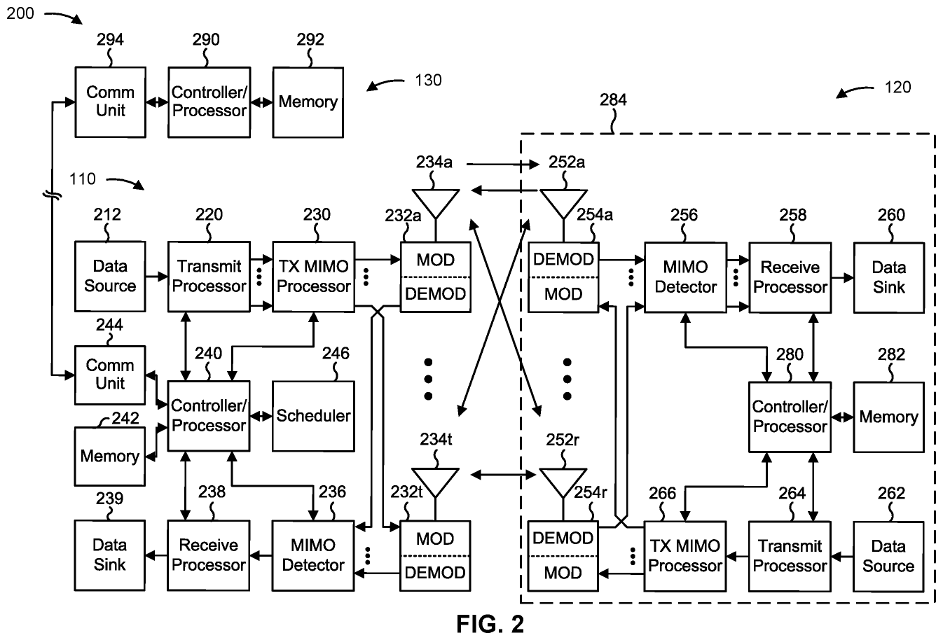

FIG. 2 is a diagram illustrating an example 200 of a base station 110 in communication with a UE 120 in a wireless network 100. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, may select a modulation and coding scheme (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS), a phase tracking reference signal (PTRS), and/or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein. A scheduler 246 may schedule UEs for data transmission on the downlink and/or uplink.

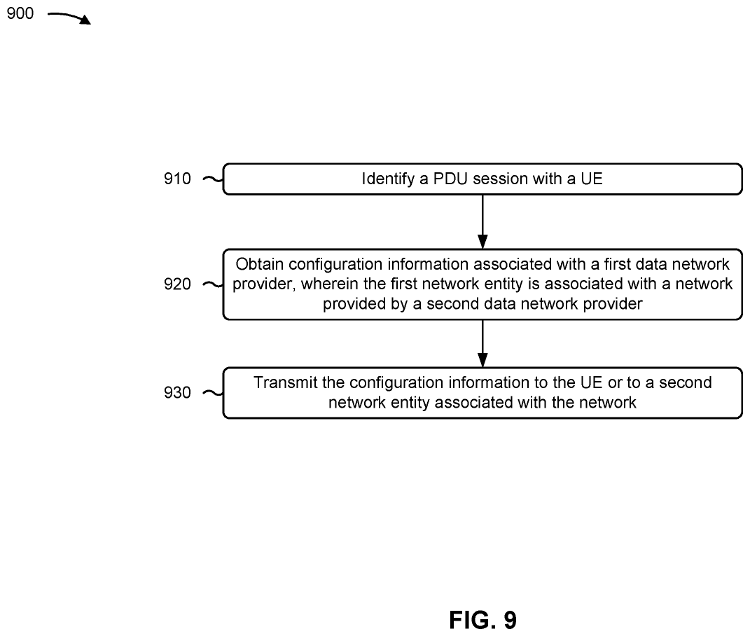

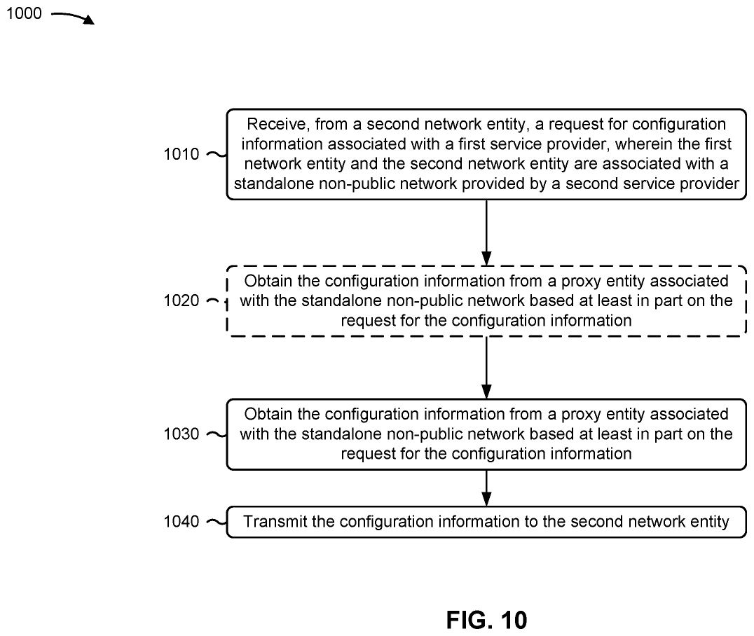

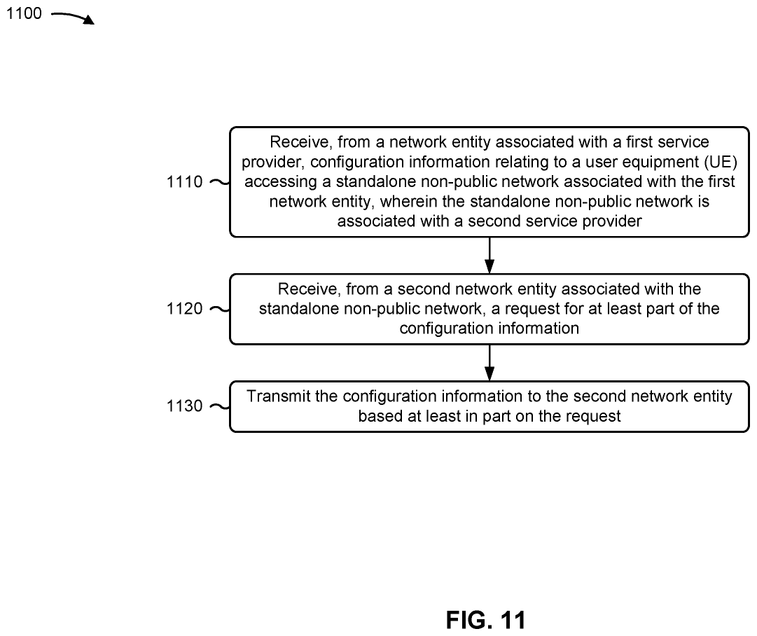

Controller/processor 240 of base station 110, controller/processor 280 of UE 120, and/or any other component(s) of FIG. 2 may perform one or more techniques associated with providing configuration information for accessing a standalone non-public network, as described in more detail elsewhere herein. For example, controller/processor 240 of base station 110, controller/processor 280 of UE 120, and/or any other component(s) of FIG. 2 may perform or direct operations of, for example, method 900 of FIG. 9, method 1000 of FIG. 10, method 1100 of FIG. 11, and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 900 of FIG. 9, method 1000 of FIG. 10, method 1100 of FIG. 11, and/or other processes as described herein. In some aspects, executing instructions may include running the instructions, converting the instructions, compiling the instructions, and/or interpreting the instructions, among other examples.

As indicated above, FIG. 2 is provided as an example. Other examples may differ from what is described with regard to FIG. 2.

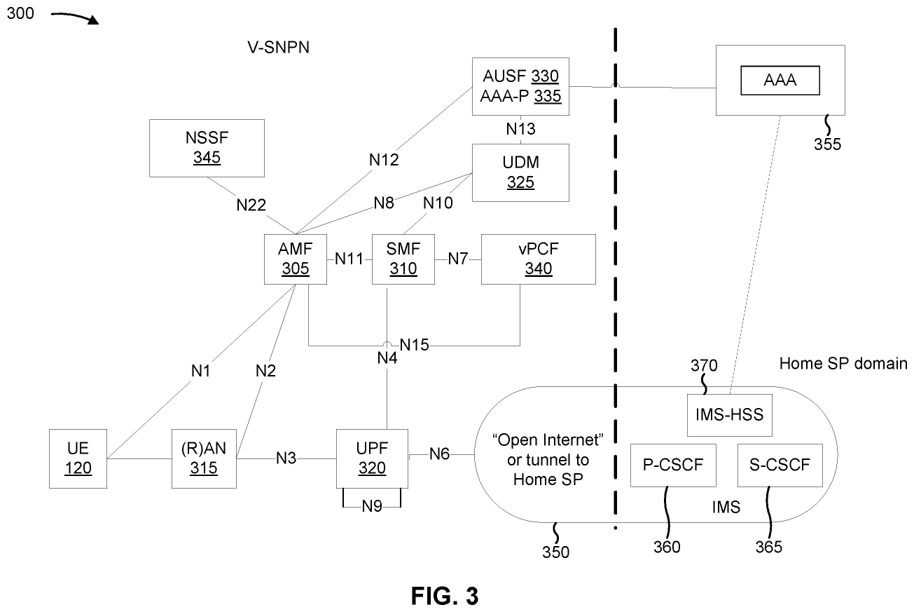

FIG. 3 is a diagram of an example environment 300 of an SNPN and a network associated with a home SP of a UE 120. The SNPN is labeled as a visited SNPN (V-SNPN) since the UE 120 is visiting the SNPN in example environment 300. An SNPN is a network that provides radio access using a radio access technology such as 5G. An SNPN is a private network which has been deployed separately from a public network, such as a public land mobile network (PLMN). In some aspects, an SNPN may not have dependency on a public network. An SNPN may provide network services to a defined user organization or group of organizations. Network entities associated with the SNPN are shown to the left of the dashed line. Network entities associated with the home SP are shown to the right of the dashed line. Interfaces between network entities are labeled (e.g., N1, N2, and so on). “Network entity” is used interchangeably with “network function” herein. Functions and/or networks of example environment 300 may interconnect via wired connections, wireless connections, or a combination of wired and wireless connections.

The SNPN may broadcast system information that the UE 120 may use to access the SNPN. Information broadcasted by the SNPN may include a PLMN identifier (which may be a private PLMN identifier from a mobile country code (MCC) 999 range), a network identifier (NID), and optionally a human readable network name. The UE 120 may be configured with one or more SNPN subscriptions. In an SNPN access mode, the UE 120 may only register with networks broadcasting both a PLMN identifier and an NID, and for which the UE 120 has credentials. In some deployments, an SNPN may not support interconnection or roaming. For example, a UE 120 may not be able to access a first SNPN using credentials associated with a second SNPN. As another example, a UE 120 may not be able to access an SNPN using credentials associated with a PLMN.

Some techniques described herein enable a UE 120 to access a non-public network (e.g., an SNPN) using third party credentials, such as provided by a home SP of the UE 120. For example, the UE 120 may successfully select and register with an SNPN that supports access to the UE 120's home SP subscription. Supported home SP types may include PLMNs, SNPNs, and other credential providers. The UE 120 may have access to SNPN services, such as local IP access and Internet access, and to home SP services, such as a voice service.

As shown, the SNPN includes an access and mobility management function (AMF) 305, an SMF 310, an access node 315 (shown as (R)AN to indicate that the access node may or may not be a radio access node), a UPF 320, a UDM 325, an AUSF 330, an AAA proxy (AAA-P) 335, a policy charging function (PCF) 340 (shown as visited PCF (vPCF)), a network slice selection function (NSSF) 345, and a data network 350. As further shown, the home SP is associated with an AAA server 355, a proxy call session control function (P-CSCF) 360, a serving call session control function (S-CSCF) 365, and an IMS home subscriber server (IMS-HSS) 370. As further shown, the functions 360, 365, and 370 may be considered part of a home SP domain associated with the home SP. The home SP may be a credential provider. The above network functions 305, 310, 315, 320, 325, 330, 335, 340, 345, 355, 360, 365, and 370 may be implemented as devices, logical functions, or a combination thereof. For example, each of the functional elements shown in FIG. 3 may be implemented on one or more devices associated with a wireless telecommunications system. In some aspects, one or more of the functional elements may be implemented on physical devices, such as an access point, a base station, a server, and/or a gateway. In some aspects, one or more of the functional elements may be implemented on a computing device of a cloud computing environment.

AMF 305 includes one or more devices that act as a termination point for non-access stratum (NAS) signaling and/or mobility management, among other examples.

SMF 310 includes one or more devices that support the establishment, modification, and release of communication sessions in the wireless telecommunications system. For example, SMF 310 may configure traffic steering policies at UPF 320 and/or may enforce UE network address allocation and policies, among other examples. In some aspects, SMF 310 may provide protocol configuration option (PCO) messaging to the UE 120 based at least in part on information received from one or more other network entities.

Access node 315 may provide the UE 120 with access to the SNPN, such as via a radio interface. For example, access node 315 may include BS 110, a radio unit (RU), a distributed unit (DU), or a central unit (CU), described in connection with FIGS. 1 and 2.

UPF 320 includes one or more devices that serve as an anchor point for intra-RAT and/or inter-RAT mobility. UPF 320 may apply rules to packets, such as rules pertaining to packet routing, traffic reporting, and/or handling user plane quality of service (QoS), among other examples. In some aspects, UPF 320 may handle the establishment and management of tunnels with the network provided by the home SP, as described in more detail elsewhere herein.

UDM 325 includes one or more devices that store user data and profiles. UDM 325 may be used for fixed access and/or mobile access.

AUSF 330 includes one or more devices that act as an authentication server and support the process of authenticating UE 120 in the wireless telecommunications system. In some aspects, AUSF 330 may communicate with AAA server 355 (e.g., via AAA proxy 335) to authenticate UE 120, as described in more detail elsewhere herein.

AAA proxy 335 includes one or more devices that interface with AAA server 355. In some aspects, as shown in example environment 300, AAA proxy 335 may be AUSF 330. In some aspects, AAA proxy 335 may be separate from AUSF 330. In some aspects, the SNPN may be implemented without an AAA proxy. For example, AAA proxy 335 may be considered optional.

PCF 340 includes one or more devices that provide a policy framework that incorporates network slicing, roaming, packet processing, and/or mobility management, among other examples.

NSSF 345 includes one or more devices that select network slice instances for UE 120. Network slicing enables an operator to deploy multiple substantially independent end-to-end networks (referred to as slices) potentially with the same infrastructure. In some implementations, each slice may be customized for different services.

Data network 350 includes one or more wired and/or wireless data networks. For example, data network 350 may include an IMS, a PLMN, a local area network (LAN), a wide area network (WAN), a metropolitan area network (MAN), a private network such as a corporate intranet, an ad hoc network, the Internet, a fiber optic-based network, a cloud computing network, a third party services network, an operator services network, an SNPN, and/or a combination of these or other types of networks. In some aspects, the UE 120 may access services provided in the home SP domain via data network 350, such as via the “open Internet” or via a tunnel to the home SP. The tunnel may be configured using configuration information provided from AAA server 355 to UPF 320 via one or more network entities, as described elsewhere herein.

AAA server 355 includes one or more devices that provide functionality to support authentication, authorization, accounting, or the like. In some aspects, AAA server 355 may use a communication protocol such as Remote Authentication Dial-In User Service (RADIUS), Diameter, or the like. In some aspects, AAA server 355 may be associated with a data network (DN), such as data network 350. For example, AAA server 355 may be a DN-AAA.

P-CSCF 360 and S-CSCF 365 may provide a central control function in the IMS to set up, establish, modify, and tear down multimedia sessions. P-CSCF 360 may be an edge access function, which may be the entry point for a UE 120 to request services from an IMS network. P-CSCF 360 may function as a proxy by accepting incoming requests and forwarding the incoming requests to an entity that can service the incoming requests. S-CSCF 365 may handle registration and session control for a registered UE 120. S-CSCF 365 may function as a registrar and may enable network location information of the UE 120 to be available at IMS-HSS 370. S-CSCF 365 may determine whether to allow or deny service to UE 120. In some aspects, S-CSCSF may provide assignment of application servers to a session, execution of session requests by locating destination endpoints and conducting signaling toward the destination endpoint, coordinating with a media resource function, maintaining session state, or the like. IMS-HSS 370 may manage home location registration, user subscription information, user profile information, mutual network-terminal authentication, radio path ciphering, integrity protection, and so on.

Communication between the AAA server 355 and the AUSF 330 or the AAA proxy 335 may enable SNPN access for UE 120 associated with a credential provider of the AAA server 355 (e.g., an entity that operates the AAA server 355). This scenario may be relevant since AAA server functionality is typically available in enterprises already or is easily deployable. In some aspects, the UE 120 may use a roaming with local break-out architecture, such as defined in a wireless telecommunication standard. Accessing the visited SNPN may enable access to the visited SNPN's services. The UE 120 may be authenticated using the credential provider's AAA server 355. In some cases, subscription information is not provided by credential provider. Therefore, a template subscription may be configured in the visited SNPN, and may be used for visiting UEs authenticated using an external AAA server such as AAA server 355. The template subscription may include, for example, allowed data network names (DNNs), allowed bitrates, or the like.

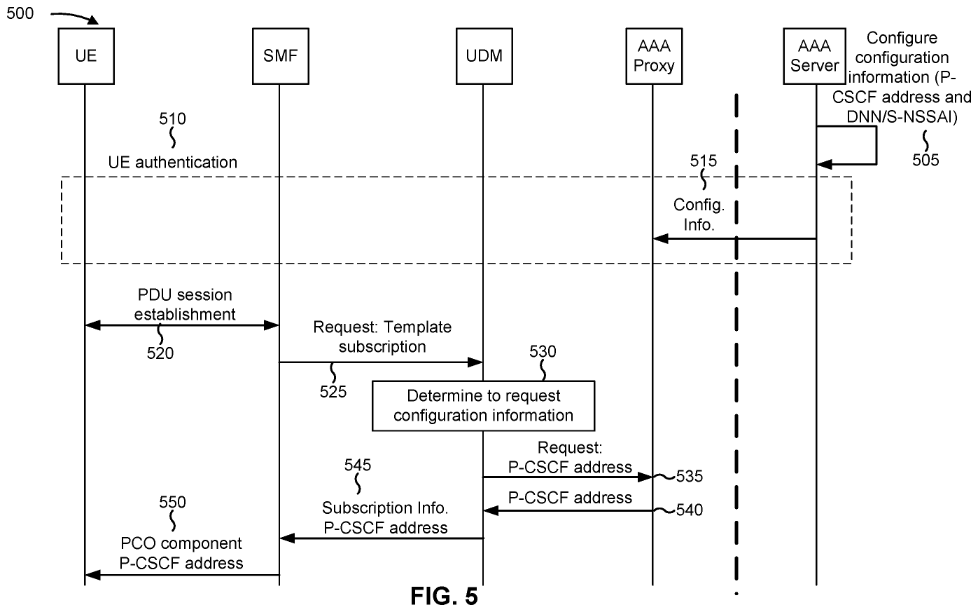

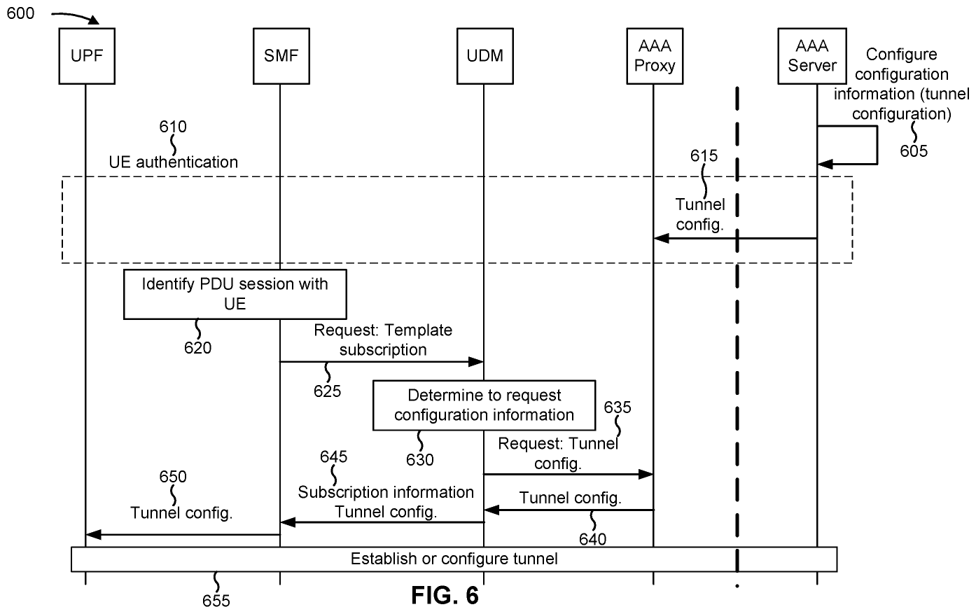

Certain issues may arise in providing configuration information for accessing a service provided by the home SP, such as via the IMS. For example, to access a service provided by the home SP, the UE 120 may use configuration information, which may include an address of P-CSCF 360 (e.g., a P-CSCF address such as an IP address, a DNN, single network slice selection assistance information (S-NSSAI), or the like), a tunnel configuration (e.g., a DNN, an S-NSSAI, a tunneling type (e.g., Layer 2 Tunneling Protocol (L2TP) or IP Security (IPSec)), a tunnel server address, a credential, an indication of whether a dedicated or shared tunnel should be established, or the like). The address of P-CSCF 360 may typically be provided to the UE 120 via protocol configuration options (PCOs) sent by a home SMF of the UE 120. However, in example environment 300, the home SP is not associated with an SMF. Therefore, the UE 120 may not receive the address of P-CSCF 360, which prevents the UE 120 from accessing the service provided by the home SP. Furthermore, if no mechanism for providing a tunnel configuration from the AAA server to the 5G system is provided, it may be difficult or impossible to configure a tunnel from a device connected to an SNPN to the home SP's domain. Also, tunneling between the SNPN and the home SP domain may not be possible for the UPF due to there not being an SMF associated with the home SP. If tunneling is not possible, privacy may be reduced and the use of secure tunneling protocols such as L2TP and IPSec may be hampered. Techniques and apparatuses described herein with regard to FIGS. 5 and 6 enable provision of such configuration information to the UE 120 or the UPF 320, which enables usage of services provided by the IMS associated with the home SP and tunneling to the home SP's network or IMS.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

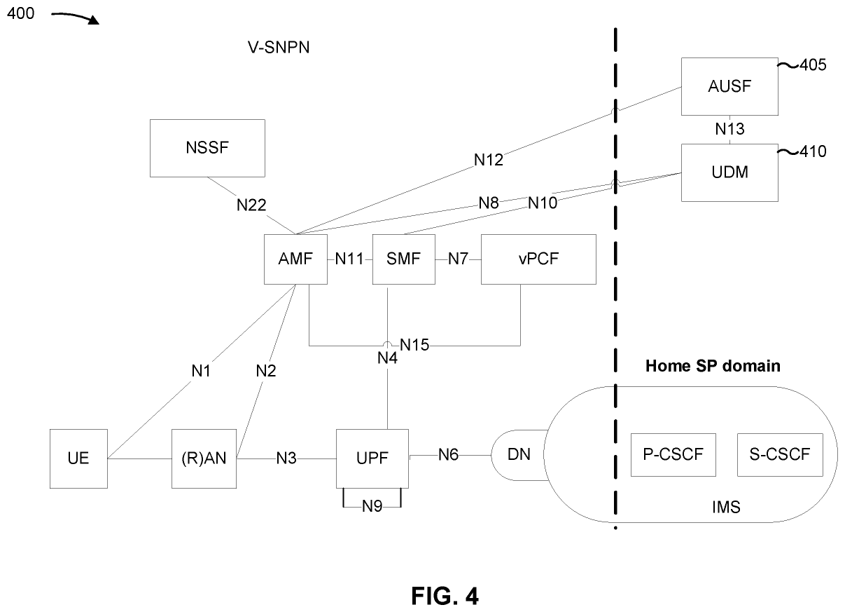

FIG. 4 is a diagram of an example environment 400 of an SNPN and a network associated with a home SP of a UE 120. The SNPN is labeled as a V-SNPN since the UE 120 is visiting the SNPN in example environment 400. Network entities associated with the SNPN are shown to the left of the dashed line. Network entities associated with the home SP are shown to the right of the dashed line. Interfaces between network entities are labeled (e.g., N1, N2, and so on). Functions and/or networks of example environment 400 may interconnect via wired connections, wireless connections, or a combination of wired and wireless connections.

As shown, the V-SNPN includes an AMF (e.g., AMF 305), an access node (e.g., access node 315), a UPF (e.g., UPF 320), a PCF (e.g., vPCF 340), an NSSF (e.g., NSSF 345), and a data network (e.g., data network 350). These network functions and networks are described in connection with FIG. 3.

In example environment 400, the home SP is associated with an AUSF 405 (e.g., AUSF 330) and a UDM 410 (e.g., UDM 325). Example environment 400 may be considered a local break-out architecture, and may enable interconnection between the SNPN and the home SN network using a roaming architecture. For example, the AUSF 405 and the UDM 410 may enable access to SNPN services (e.g., local data services or Internet access). The architecture of example environment 400 may apply to home SPs that implement an AUSF and a UDM, such as a PLMN provider, an SNPN provider, or the like. As shown, the AUSF 405 may interface with the AMF, the UDM 410 may interface with the AMF and the SMF, and the AUSF 405 and the UDM 410 may interface with each other. Furthermore, the home SP is associated with an IMS, which includes a P-CSCF (e.g., P-CSCF 360) and an S-CSCF (e.g., S-CSCF 365). In some aspects, the IMS may include an IMS-HSS (e.g., IMS-HSS 370).

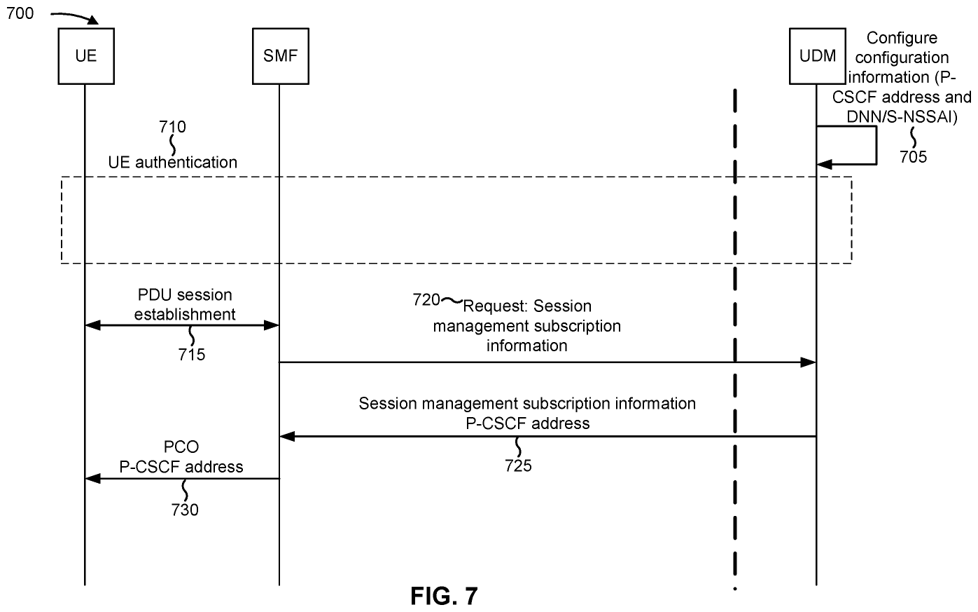

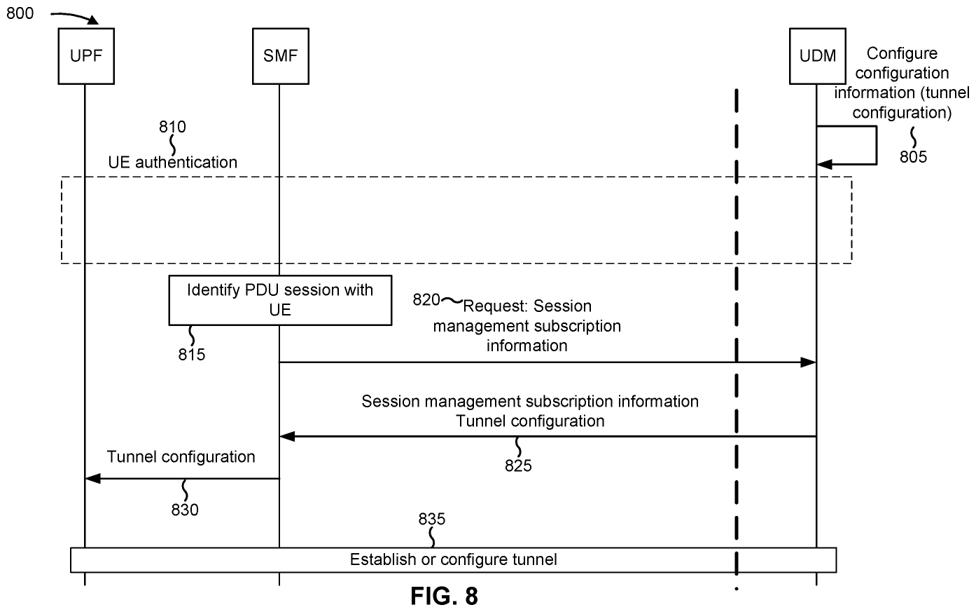

Certain issues may arise in providing configuration information for accessing a service provided by the home SP, such as via the IMS. For example, to access a service provided by the home SP, the UE 120 may use configuration information, which may include an address of the P-CSCF (e.g., a P-CSCF address such as an IP address, a DNN, single network slice selection assistance information (S-NSSAI), or the like), a tunnel configuration (e.g., a DNN, an S-NSSAI, a tunneling type (e.g., Layer 2 Tunneling Protocol (L2TP) or IP Security (IPSec)), a tunnel server address, a credential, an indication of whether a dedicated or shared tunnel should be established, or the like). The address of the P-CSCF may typically be provided to the UE 120 via PCOs sent by a home SMF of the UE 120. However, in example environment 400, the home SP is not involved in session establishment on the SNPN. Therefore, the UE 120 may not receive the address of the P-CSCF, which prevents the UE 120 from accessing the service provided by the home SP. Furthermore, there may not be a mechanism for providing a tunnel configuration from the AAA server to the 5G system. Therefore, tunneling between the SNPN and the home SP domain may not be possible for the UPF, which degrades privacy and hampers the use of secure tunneling protocols such as L2TP and IPSec. Techniques and apparatuses described herein with regard to FIGS. 7 and 8 enable provision of such configuration information to the UE 120 or the UPF by the AUSF or the UDM, which enables usage of services provided by the IMS associated with the home SP and tunneling to the home SP's network or IMS.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

FIG. 5 is a diagram illustrating an example 500 of provision of configuration information from a home SP for a UE visiting an SNPN. Example 500 includes a UE (e.g., UE 120), an SMF (e.g., SMF 310), a UDM (e.g., UDM 325), an AAA proxy (e.g., AUSF 330 and/or AAA proxy 335), and an AAA server (e.g., AAA server 355). Functions associated with an SNPN are shown to the left of the vertical dashed line, and functions associated with a home SP are shown to the right of the vertical dashed line. In some aspects, the operations of example 500 may be performed by one or more devices of example environment 300. FIG. 5 shows an example where a P-CSCF address is passed from a third party AAA server to a 5GS when authenticating a UE, and an SMF in a visited SNPN creates a PCO with the P-CSCF address and signals the PCO to the UE.

At 505, the AAA server (e.g., a home SP associated with the AAA server) may configure a set of configuration information. In some aspects, the AAA server may receive the configuration information. The configuration information may include any information that can be signaled to the UE via a PCO component of a message. In example 500, the configuration information includes at least one of an address for a P-CSCF (e.g., P-CSCF 360), a DNN, or an S-NSSAI. In some aspects, the configuration information may indicate an association between the DNN and S-NSSAI (DNN/S-NSSAI) and the address for the P-CSCF. In some aspects, the configuration information may include a tunnel configuration, as described elsewhere herein. This configuration information may be used by UE 120 to access a service provided by an IMS of the home SP. In some aspects, if the AAA server uses a RADIUS protocol, the configuration information may be configured using a Vendor-Specific-Attributes parameter.

At 510, the UE may be authenticated with regard to the SNPN. For example, the UE may attempt to establish a connection with the SNPN (e.g., may register with the SNPN). In order to establish the connection with the SNPN, a 5G system (5GS) of the SNPN (e.g., one or more of the network entities of the SNPN in example 300) may authenticate the UE with the AAA server. For example, an authentication procedure may run between the 5GS and the AAA server. In some aspects, the AAA proxy may handle interaction with the AAA server for the purpose of authentication.

At 515, the AAA server may provide the configuration information to the AAA proxy. In example 500, the AAA server provides the configuration information to the AAA proxy during the authentication of the UE, as indicated by the provision of the configuration information being within the dashed box. In some aspects, the AAA server may provide the configuration information to the AAA proxy after authentication (e.g., successful authentication) of the UE, or before authentication of the UE. In some aspects, the AAA server may provide the configuration information based at least in part on authentication of the UE. For example, the AAA server may provide configuration information relating to the UE and/or to a service provided by the home SP that the UE is attempting to access. Additionally, or alternatively, the authentication may trigger the AAA server to provide the configuration information.

At 520, the UE and the SMF may identify a PDU session. For example, the UE and the SMF may attempt to establish a PDU session or may successfully establish a PDU session. The UE may establish the PDU session for the DNN/S-NSSAI indicated by the configuration information. For example, the PDU session may be associated to the DNN/S-NSSAI. The UE may establish the PDU session to utilize a service provided by the home SP. For example, the UE may have a subscription to the service, and thus the DNN/S-NSSAI may be known to the UE.

At 525, the SMF may request, from the UDM, a subscription for the UE. For example, the SMF in the SNPN may query the UDM for the subscription. In some aspects, the UDM may provide a template subscription based at least in part on the request for the subscription. As mentioned above, a template subscription may be used for all visiting UEs that are authenticated by an AAA server outside of the SNPN.

At 530, the UDM may determine to request the configuration information. For example, the UDM may determine to request at least part of the configuration information (e.g., an address for a P-CSCF corresponding to a DNN/S-NSSAI associated with the PDU session). In some aspects, the UDM may determine to request the configuration information based at least in part on an explicit indication in the subscription. For example, the subscription may include information indicating to request the configuration information. In some aspects, the UDM may determine to request the configuration information based at least in part on a local configuration. For example, a configuration of the UDM may cause the UDM to request the configuration information.

At 535, the UDM may request the configuration information from the AAA proxy. For example, the UDM may query the AAA proxy for at least part of the configuration information. In example 500, the UDM queries the AAA proxy to determine if an address for a P-CSCF has been provided to (e.g., made available to) the AAA proxy (e.g., by the AAA server) for the DNN/S-NSSAI associated with the PDU session. For example, the UDM may provide a request for an address for a P-CSCF, and the request may identify the DNN/S-NSSAI. Alternatively, the UDM may provide a request for any available configuration information for this UE. At 540, the AAA proxy may provide the address for the P-CSCF to the UDM based at least in part on the request. For example, the AAA proxy may determine that an address for a P-CSCF, corresponding to the DNN/S-NSSAI, is available, and may provide the address based at least in part on the request. Alternatively, the AAA proxy may provide all available configuration information based at least in part on the request.

In some aspects, the AAA proxy may provide the address for the P-CSCF to an AMF of the SNPN, and the AMF may provide the address for the P-CSCF to the SMF. For example, the AAA proxy may provide the address to the AMF based at least in part on a request from the UDM (e.g., as part of the authentication procedure shown by reference number 510).

At 545, the UDM may provide the address for the P-CSCF to the SMF in the visited SNPN. In some aspects, the UDM may provide the address for the P-CSCF with subscription information relating to the UE and/or the SMF. At 550, the SMF in the visited SNPN may provide the address for the P-CSCF to the UE. For example, the SMF may provide the address for the P-CSCF in a PCO component of a message such as a non-access stratum (NAS) message. In such a case, the SMF may create the PCO, embed the address for the P-CSCF in the PCO, and deliver the PCO to the UE. The UE may use the address for the P-CSCF to access the service provided by the home SP based at least in part on the DNN/S-NSSAI. In this way, a UE visiting an SNPN can obtain an address for a P-CSCF associated with a home SN that does not have an SMF, thereby enabling the UE to access subscribed services provided by an IMS of the home SNPN.

As indicated above, FIG. 5 is provided as an example. Other examples may differ from what is described with regard to FIG. 5.

FIG. 6 is a diagram illustrating an example 600 of provision of configuration information from a home SP for a UE accessing an SNPN, in accordance with the present disclosure. Example 600 includes a UE (e.g., UE 120), an SMF (e.g., SMF 310), a UDM (e.g., UDM 325), an AAA proxy (e.g., AUSF 330 and/or AAA proxy 335), and an AAA server (e.g., AAA server 355). Functions associated with an SNPN are shown to the left of the vertical dashed line, and functions associated with a home SP are shown to the right of the vertical dashed line. In some aspects, the operations of example 600 may be performed by one or more devices of example environment 300. Example 600 shows how a tunnel configuration can be passed from a third party AAA server to a 5GS associated with an SNPN when authenticating a UE, and how a UPF can establish a tunnel based at least in part on the tunnel configuration received from the AAA server. Example 600 relates to a data network provider, referred to in connection with example 600 as a home service provider (SP). In some aspects, the data network provider may be an enterprise.

At 605, the AAA server (e.g., a home data network provider associated with the AAA server) may configure a set of configuration information. In some aspects, the AAA server may receive the configuration information. In example 600, the configuration information includes a tunnel configuration. A tunnel configuration may include, for example, a DNN, an S-NSSAI, information indicating a tunneling type (e.g., L2TP, IPSec), a tunnel server address (e.g., an L2TP network server's address, an IPSec network server's address), one or more credentials (e.g., a tunnel password), an indication of whether a dedicated or shared tunnel should be established, or the like. In some aspects, the configuration information may indicate an association between the DNN/S-NSSAI and one or more elements of the tunnel configuration. This configuration information may be used by the UPF to establish a tunnel associated with enabling a UE to access a service provided by an IMS of the home SP. In some aspects, if the AAA server uses a RADIUS protocol, the configuration information may be configured using a Vendor-Specific-Attributes parameter.

At 610, the UE may be authenticated with regard to the SNPN. For example, the UE may attempt to establish a connection with the SNPN. In order to establish the connection with the SNPN, a 5GS of the SNPN (e.g., one or more of the network entities of the SNPN in example 300) may authenticate the UE with the AAA server. For example, an authentication procedure may run between the 5GS and the AAA server. In some aspects, the AAA proxy may handle interaction with the AAA server for the purpose of authentication.

At 615, the AAA server may provide the configuration information to the AAA proxy. In example 600, the AAA server provides the configuration information to the AAA proxy during the authentication of the UE, as indicated by the provision of the configuration information being within the dashed box. In some aspects, the AAA server may provide the configuration information to the AAA proxy after authentication (e.g., successful authentication) of the UE, or before authentication of the UE. In some aspects, the AAA server may provide the configuration information based at least in part on authentication of the UE. For example, the AAA server may provide configuration information relating to the UE and/or to a service provided by the home SP that the UE is attempting to access. Additionally, or alternatively, the authentication may trigger the AAA server to provide the configuration information. It should be noted that the AAA proxy is optional, and in some aspects, the AAA server may communicate with another network function of the SNPN.

At 620, the SMF may identify a PDU session. For example, the UE and the SMF may attempt to establish a PDU session or may successfully establish a PDU session. The SMF may establish the PDU session for a DNN/S-NSSAI indicated by the configuration information. For example, the PDU session may be associated to the DNN/S-NSSAI. The UE and/or SMF may establish the PDU session to utilize a service provided by the home SP.

At 625, the SMF may request, from the UDM, the subscription for the UE. For example, the SMF in the SNPN may query the UDM for the subscription. In some aspects, the subscription may be a template subscription. As mentioned above, a template subscription may be used for all visiting UEs that are authenticated by an AAA server outside of the SNPN. At 630, the UDM may determine to request the configuration information. For example, the UDM may determine to request at least part of the configuration information (e.g., a tunnel configuration associated with the DNN/S-NSSAI associated with the PDU session). In some aspects, the UDM may determine to request the configuration information based at least in part on an explicit indication in the subscription. For example, the subscription may include information indicating to request the configuration information. In some aspects, the UDM may determine to request the configuration information based at least in part on a local configuration. For example, a configuration of the UDM may cause the UDM to request the configuration information.

At 635, the UDM may request the configuration information from the AAA proxy. For example, the UDM may query the AAA proxy for at least part of the configuration information. In example 600, the UDM queries the AAA proxy to determine if a tunnel configuration has been provided to (e.g., made available to) the AAA proxy (e.g., by the AAA server) for the DNN/S-NSSAI associated with the PDU session. For example, the UDM may provide a request for a tunnel configuration, and the request may identify the DNN/S-NSSAI. Alternatively, the UDM may provide a request for any available configuration information for this UE. At 640, the AAA proxy may provide the tunnel configuration to the UDM based at least in part on the request. For example, the AAA proxy may determine that a tunnel configuration, corresponding to the DNN/S-NSSAI, is available, and may provide the tunnel configuration based at least in part on the request. Alternatively, the AAA proxy may provide all available configuration information based at least in part on the request. In some aspects, the AAA proxy may be optional, or may not be implemented in the SNPN.

In some aspects, the AAA proxy may provide the tunnel configuration to an AMF of the SNPN, and the AMF may provide the tunnel configuration to the SMF. For example, the AAA proxy may provide the tunnel configuration to the AMF based at least in part on the authentication request from the AMF (e.g., as part of the authentication procedure shown by reference number 610).

At 645, the UDM may provide the tunnel information to the SMF in the visited SNPN. In some aspects, the UDM may provide the tunnel information with subscription information relating to the UE and/or the SMF. In some aspects, the subscription information may include an indication for the SMF to authenticate the UE with the AAA server. At 650, the SMF in the visited SNPN may provide the tunnel information to the UPF. In some aspects, the SMF may authenticate the UE with the AAA server, such as in connection with establishing a PDU session and based at least in part on the indication in the subscription information. In such examples, the SMF may receive the tunnel information from the AAA server. In some aspects, the SMF may communicate with the AAA server via the UPF (for example, the AAA proxy and the UPF may be the same entity). In some other aspects, the SMF may communicate directly with the AAA server. At 655, the UPF may establish a tunnel based at least in part on the configuration information, or may configure a tunnel based at least in part on the configuration information. For example, if the tunnel configuration indicates to use a shared tunnel, the UPF may configure a previously established tunnel based at least in part on the tunnel configuration. If the tunnel configuration does not indicate to use a shared tunnel, the UPF may establish a tunnel based at least in part on the tunnel configuration. In this way, a tunnel configuration can be provided from a third-party AAA server to a UPF associated with a UE visiting an SNPN, which enables the UPF to establish a tunnel to a network associated with a home SP associated with the AAA server, thereby facilitating access to home SP services via an SNPN when the home SP has not implemented an SMF and improving security.

As indicated above, FIG. 6 is provided as an example Other examples may differ from what is described with regard to FIG. 6.

FIG. 7 is a diagram illustrating an example 700 of provision of configuration information from a home SP for a UE visiting an SNPN, in accordance with the present disclosure. Example 700 includes a UE (e.g., UE 120), an SMF (e.g., SMF 310), and a UDM (e.g., UDM 410). Functions associated with an SNPN are shown to the left of the vertical dashed line, and functions associated with a home SP are shown to the right of the vertical dashed line. In some aspects, the operations of example 700 may be performed by one or more devices of example environment 400. Example 700 shows how an address for a P-CSCF can be configured in a third party UDM (e.g., associated with a home SP and external to the SNPN) and signaled to a visited SMF, and how a visited SMF can provide the address for the P-CSCF to the UE, such as by creating a PCO with the address for the P-CSCF and signaling the PCO to the UE.

At 705, the UDM (e.g., a home SP associated with the UDM) may configure a set of configuration information. In some aspects, the UDM may receive the configuration information. The configuration information may include any information that can be signaled to UE via a PCO component of a message. In example 700, the configuration information includes at least one of an address for a P-CSCF (e.g., P-CSCF 360), a DNN, or an S-NSSAI. In some aspects, the configuration information may indicate an association between the DNN/S-NSSAI and the address for the P-CSCF. This configuration information may be used by UE 120 to access a service provided by an IMS of the home SP.

At 710, the UE may be authenticated with regard to the SNPN. For example, the UE may attempt to establish a connection with the SNPN. In order to establish the connection with the SNPN, a 5GS of the SNPN (e.g., one or more of the network entities of the SNPN in example 400) may authenticate the UE with an AUSF associated with the home SP (e.g., AUSF 405, not shown in FIG. 7). For example, an authentication procedure may run between the 5GS and the AUSF.

At 715, the UE and the SMF may identify a PDU session. For example, the UE and/or the SMF may attempt to establish a PDU session or may successfully establish a PDU session. The UE may establish the PDU session for the DNN/S-NSSAI indicated by the configuration information. For example, the PDU session may be associated to the DNN/S-NSSAI. The UE may establish the PDU session to utilize a service provided by the home SP. For example, the UE may have a subscription to the service, and thus the DNN/S-NSSAI may be known to the UE.

At 720, the SMF may request, from the UDM, session management subscription information. Session management subscription information (also referred to as session management subscription data) includes data used for PDU session establishment relating to one or more subscriptions associated with the UE. In some aspects, the SMF may request the session management subscription information based at least in part on a DNN/S-NSSAI (such as the DNN/S-NSSAI identified by the configuration information), a supported feature, a PLMN identifier, or the like. In some aspects, the SMF may request the configuration information (e.g., implicitly based at least in part on requesting the session management subscription information, or explicitly).

At 725, the UDM may provide the address for the P-CSCF to the SMF in the visited SNPN. In some aspects, the UDM may provide the address for the P-CSCF with or as part of session management subscription information requested by the SMF. At 730, the SMF in the visited SNPN may provide the address for the P-CSCF to the UE. For example, the SMF may provide the address for the P-CSCF in a PCO component of a message such as an NAS message. In such a case, the SMF may create the PCO, embed the address for the P-CSCF in the PCO, and deliver the PCO to the UE. The UE may use the address for the P-CSCF to access the service provided by the home SP based at least in part on the DNN/S-NSSAI. In this way, a UE visiting an SNPN can obtain an address for a P-CSCF associated with a home SN that does not have an SMF, thereby enabling the UE to access subscribed services provided by an IMS of the home SN.

As indicated above, FIG. 7 is provided as an example Other examples may differ from what is described with regard to FIG. 7.

FIG. 8 is a diagram illustrating an example 800 of provision of configuration information from a home SP for a UE visiting an SNPN, in accordance with the present disclosure. Example 800 includes a UE (e.g., UE 120), an SMF (e.g., SMF 310), and a UDM (e.g., UDM 410). Functions associated with an SNPN are shown to the left of the vertical dashed line, and functions associated with a home SP are shown to the right of the vertical dashed line. In some aspects, the operations of example 800 may be performed by one or more devices of example environment 400.

At 805, the UDM (e.g., a home SP associated with the UDM) may configure a set of configuration information. In some aspects, the UDM may receive the configuration information. In example 800, the configuration information includes a tunnel configuration. A tunnel configuration may include, for example, a DNN, an S-NSSAI, information indicating a tunneling type (e.g. L2TP, IPSec), a tunnel server address, one or more credentials, an indication of whether dedicated or shared tunnel should be established, or the like. In some aspects, the configuration information may indicate an association between the DNN/S-NSSAI and one or more elements of the tunnel configuration. This configuration information may be used by the UPF to establish a tunnel associated with enabling a UE to access a service provided by an IMS of the home SP.

At 810, the UE may be authenticated with regard to the SNPN. For example, the UE may attempt to establish a connection with the SNPN. In order to establish the connection with the SNPN, a 5GS of the SNPN (e.g., one or more of the network entities of the SNPN in example 400) may authenticate the UE with an AUSF associated with the home SP (e.g., AUSF 405, not shown in FIG. 8). For example, an authentication procedure may run between the 5GS and the AUSF.

At 815, the UE and the SMF may identify a PDU session. For example, the UE and the SMF may attempt to establish a PDU session or may successfully establish a PDU session. The UE may establish the PDU session for the DNN/S-NSSAI indicated by the configuration information. For example, the PDU session may be associated to the DNN/S-NSSAI. The UE may establish the PDU session to utilize a service provided by the home SP. For example, the UE may have a subscription to the service, and thus the DNN/S-NSSAI may be known to the UE.

At 820, the SMF may request, from the UDM, session management subscription information. Session management subscription information includes data used for PDU session establishment relating to one or more subscriptions associated with the UE. In some aspects, the SMF may request the session management subscription information based at least in part on a DNN/S-NSSAI (such as the DNN/S-NSSAI identified by the configuration information), a supported feature, a PLMN identifier, or the like. In some aspects, the SMF may request the configuration information (e.g., implicitly based at least in part on requesting the session management subscription information, or explicitly).

At 825, the UDM may provide the tunnel configuration to the SMF in the visited SNPN. In some aspects, the UDM may provide the tunnel configuration with or as part of session management subscription information requested by the SMF. At 830, the SMF in the visited SNPN may provide the tunnel configuration to the UPF. At 835, the UPF may establish a tunnel based at least in part on the configuration information, or may configure a tunnel based at least in part on the configuration information. For example, if the tunnel configuration indicates to use a shared tunnel, the UPF may configure a previously established tunnel based at least in part on the tunnel configuration. If the tunnel configuration does not indicate to use a shared tunnel, the UPF may establish a tunnel based at least in part on the tunnel configuration. In this way, a tunnel configuration can be provided from a UDM associated with a home SP of a UE visiting an SNPN to a UPF of the SNPN, which enables the UPF to establish a tunnel to a network associated with the home, thereby facilitating access to home SP services via an SNPN when the home SP has not implemented an SMF.

As indicated above, FIG. 8 is provided as an example Other examples may differ from what is described with regard to FIG. 8.

FIG. 9 is a flowchart of an example method 900 of wireless communication. The method 900 may be performed by, for example, a first network entity (e.g., SMF 310, the SMF of FIG. 4, AMF 305, the AMF of FIG. 4).

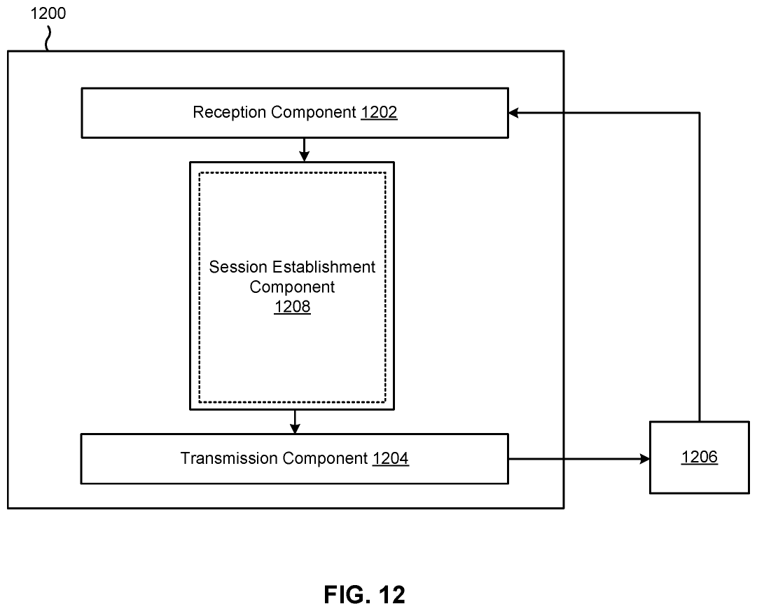

At 910, the first network entity may identify a PDU session with a UE. For example, the first network entity (e.g., using session establishment component 1208, depicted in FIG. 12) may identify a PDU session with a UE (e.g., UE 120), as described above in connection with, for example, FIG. 5 at 520, FIG. 6 at 620, FIG. 7 at 715, and FIG. 8 at 815. In some aspects, the first network entity may be associated with a second data network provider, such as a second service provider. The second data network provider may provide a network (and the first network entity may be associated with the network), such as an SNPN or a public network. The configuration information may be associated with a first data network provider, such as a first service provider. In some aspects, the first network entity is an authentication, authorization, and accounting server (e.g., AAA server 355), and the configuration information is obtained via one or more third network entities (e.g., AUSF 330, AAA proxy 335, UDM 325, AMF 305) associated with the standalone non-public network. In some aspects, the network entity associated with the first service provider is a unified data management function (e.g., UDM 410) of a network associated with the first service provider. The configuration information may include a tunnel configuration for a tunnel between a second network entity associated with the first network and a second network associated with the first data network provider

At 920, the first network entity may obtain configuration information associated with a first data network provider, wherein the first network entity is associated with a network provided by a second data network provider. For example, the first network entity (e.g., using reception component 1202, depicted in FIG. 12) may obtain, based at least in part on identifying the PDU session, configuration information associated with a first data network provider (e.g., service provider), wherein the first network entity is associated with a network (e.g., an SNPN or a public network) provided by a second data network provider (e.g., service provider), as described above in connection with, for example, FIG. 5 at 525 and 545, FIG. 6 at 625 and 645, FIG. 7 at 720 and 725, and FIG. 8 at 820 and 825. In some aspects, obtaining the configuration information further comprises requesting, from a third network entity (e.g., AMF 305, UDM 325) associated with the standalone non-public network, a template subscription indicating to request the configuration information, wherein the third network entity is an access and mobility management function or a unified data management function. In some aspects, requesting the template subscription indicating to request the configuration information is based at least in part on successful authentication of the UE. In some aspects, obtaining the configuration information further comprises obtaining the configuration information from a network entity (e.g., AAA server 355, UDM 410) associated with the first service provider.

At 930, the first network entity may transmit the configuration information to the UE or to a second network entity associated with the standalone non-public network. For example, the first network entity (e.g., using transmission component 1204, depicted in FIG. 12) may transmit the configuration information to the UE or to a second network entity (e.g., UPF 320, the UPF of FIG. 4) associated with the standalone non-public network, as described above in connection with, for example, FIG. 5 at 550, FIG. 6 at 650, FIG. 7 at 730, and FIG. 8 at 830. In some aspects, transmitting the configuration information to the UE further comprises transmitting the configuration information to the UE in a PCO component of a message. In some aspects, the configuration information transmitted to the UE includes a proxy call session control function address for a proxy call session control function associated with the first service provider. In some aspects, the configuration information transmitted to the second network entity includes a tunnel configuration for a tunnel between the second network entity and a network associated with the first service provider, wherein the second network entity is a user plane function associated with the UE (e.g., UPF 320, the UPF of FIG. 4). In some aspects, the tunnel configuration is for a shared tunnel between multiple UEs and the network associated with the first service provider.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed by, for example, a first network entity (e.g., UDM 325, UDM 410, AMF 305, the AMF of FIG. 4).

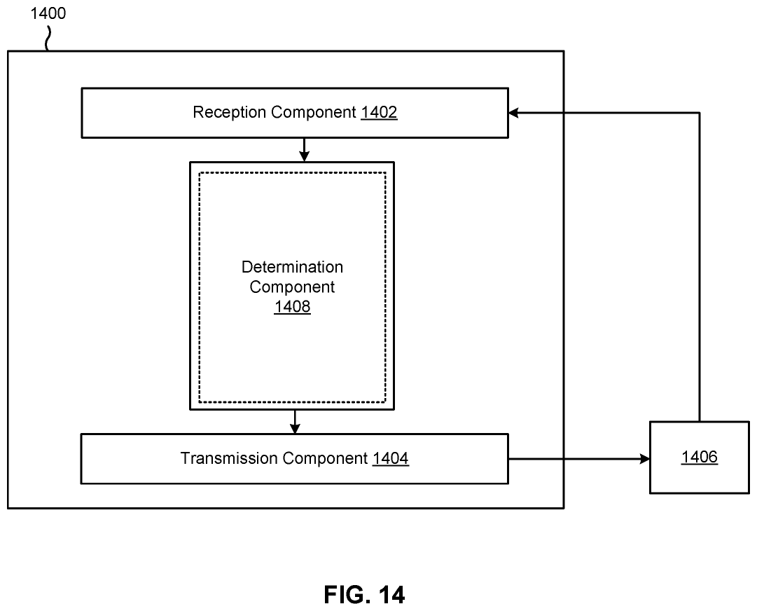

At 1010, the first network entity may receive, from a second network entity, a request for configuration information associated with a first service provider, wherein the first network entity and the second network entity are associated with a standalone non-public network provided by a second service provider. For example, the first network entity (e.g., using reception component 1402, depicted in FIG. 14) may receive, from a second network entity (e.g., AMF 305, SMF 310, the AMF of FIG. 4, the SMF of FIG. 4), a request for configuration information associated with a first service provider, wherein the first network entity and the second network entity are associated with a standalone non-public network provided by a second service, as described above in connection with, for example, FIG. 5 at 525 and FIG. 6 at 625. In some aspects, the request is received based at least in part on a PDU session being established (e.g., identified) between the UE and the second network entity. In some aspects, the configuration information includes a proxy call session control function address for a proxy call session control function (P-CSCF 360, the P-CSCF of FIG. 4) associated with the first service provider. In some aspects, the configuration information includes a tunnel configuration for a tunnel between the second network entity and a network associated with the first service provider.

At 1020, the first network entity may determine (e.g., using determination component 1408, depicted in FIG. 14) that the configuration information is to be obtained from the proxy entity based at least in part on the request for the configuration information or based at least in part on a configuration of the first network entity. The dashed border of the block shown by 1020 indicates that the action indicated by 1020 is optional.

At 1030, the first network entity may obtain the configuration information from a proxy entity associated with the standalone non-public network based at least in part on the request for the configuration information. For example, the first network entity (e.g., using reception component 1402, depicted in FIG. 14) may obtain the configuration information from a proxy entity (e.g., AUSF 330, AAA proxy 335) associated with the standalone non-public network based at least in part on the request for the configuration information, as described above in connection with, for example, FIG. 5 at 535 and 540 and FIG. 6 at 635 and 640.

In some aspects, obtaining the configuration information further comprises requesting the configuration information from the proxy entity, wherein the configuration information is available to the proxy entity based at least in part on authentication of the UE with regard to the standalone non-public network, and wherein the configuration information relates to network slice selection assistance information (e.g., an S-NSSAI) or to a data network name (e.g., a DNN) associated with the network slice selection assistance information (cumulatively, DNN/S-NSSAI).

At 1040, the first network entity may transmit the configuration information to the second network entity. For example, the first network entity (e.g., using transmission component 1404, depicted in FIG. 14) may transmit the configuration information to the second network entity, as described above in connection with, for example, FIG. 5 at 545 and FIG. 6 at 645. In some aspects, the configuration information is transmitted to the second network entity as part of subscription information associated with the second network entity.

In some aspects, the first network entity is a unified data management function (UDM 325, UDM 410) or an access and mobility management function (AMF 305), and the second network entity is a session management function (SMF 310, the SMF of FIG. 4).

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed by, for example, a first network entity (e.g., AUSF 330, AAA proxy 335).

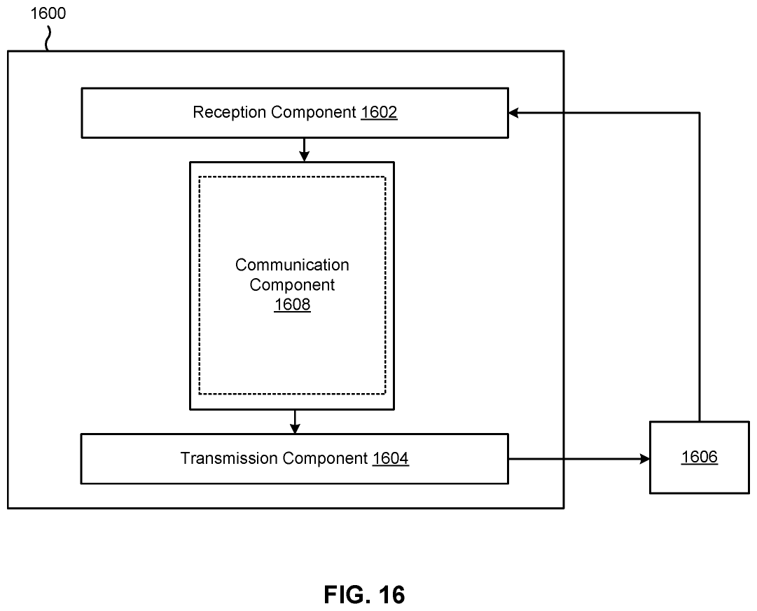

At 1110, the first network entity may receive, from a network entity associated with a first service provider, configuration information relating to a UE accessing a standalone non-public network associated with the first network entity. For example, the first network entity (e.g., using reception component 1602, depicted in FIG. 16) may receive, from a network entity associated with a first service provider (e.g., AAA server 355), configuration information relating to a UE accessing a standalone non-public network associated with the first network entity, wherein the standalone non-public network is associated with a second service provider, as described above in connection with, for example, FIG. 5 at 515 and FIG. 6 at 615. In some aspects, receiving the configuration information is based at least in part on the UE being authenticated on the standalone non-public network. In some aspects, the configuration information includes at least one of a proxy call session control function (P-CSCF) address for a P-CSCF associated with the first service provider, networking slice selection assistance information associated with the first service provider, or a data network name associated with the first service provider.

In some aspects, the configuration information includes a tunnel configuration for a tunnel between the second network entity and a network associated with the first service provider, wherein the tunnel configuration includes at least one of a data network name associated with the first service provider, networking slice selection assistance information associated with the first service provider, a tunneling type associated with a tunnel, a tunnel server address associated with the tunnel, a credential associated with the tunnel, or an indication of whether the tunnel is a shared tunnel or a dedicated tunnel.

At 1120, the first network entity may receive, from a second network entity associated with the standalone non-public network, a request for at least part of the configuration information. For example, the first network entity (e.g., using reception component 1602, depicted in FIG. 16) may receive, from a second network entity (e.g., AMF 305, SMF 310, UDM 325) associated with the standalone non-public network, a request for at least part of the configuration information, as described above in connection with, for example, FIG. 5 at 535 and FIG. 6 at 635.

At 1130, the first network entity may transmit the configuration information to the second network entity based at least in part on the request. For example, the first network entity (e.g., using transmission component 1604, depicted in FIG. 16) may transmit the configuration information to the second network entity based at least in part on the request, as described above in connection with, for example, FIG. 5 at 540 and FIG. 6 at 640.

In some aspects, the first network entity is an authentication server function and the second network entity is an access and mobility management function or a unified data management function.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a block diagram of an example apparatus 1200 for wireless communication. The apparatus 1200 may be a first network entity (e.g., SMF 310, the SMF of FIG. 4, AMF 305, the AMF of FIG. 4), or a first network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a session establishment component 1208, among other examples.

In some aspects, the apparatus 1200 may be configured to perform one or more operations described herein in connection with FIGS. 3-8. Additionally, or alternatively, the apparatus 1200 may be configured to perform one or more processes described herein, such as method 900 of FIG. 9, or a combination thereof. In some aspects, the apparatus 1200 and/or one or more components shown in FIG. 12 may include one or more components of the first network entity described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the first network entity described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the first network entity described above in connection with FIG. 2. In some aspects, the transmission component 1204 may be co-located with the reception component 1202 in a transceiver. In some aspects, the transmission component 1204 may interface with a radio unit which may, or may not, be co-located with the transmission component 1204. For example, the transmission component 1204 may be associated with a distributed unit (DU) of a disaggregated radio access network deployment.

The session establishment component 1208 may identify a PDU session with a UE. The reception component 1202 may obtain, based at least in part on identifying the PDU session, configuration information associated with a first service provider, wherein the first network entity is associated with a standalone non-public network provided by a second service provider. The transmission component 1204 may transmit the configuration information to the UE or to a second network entity associated with the standalone non-public network.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

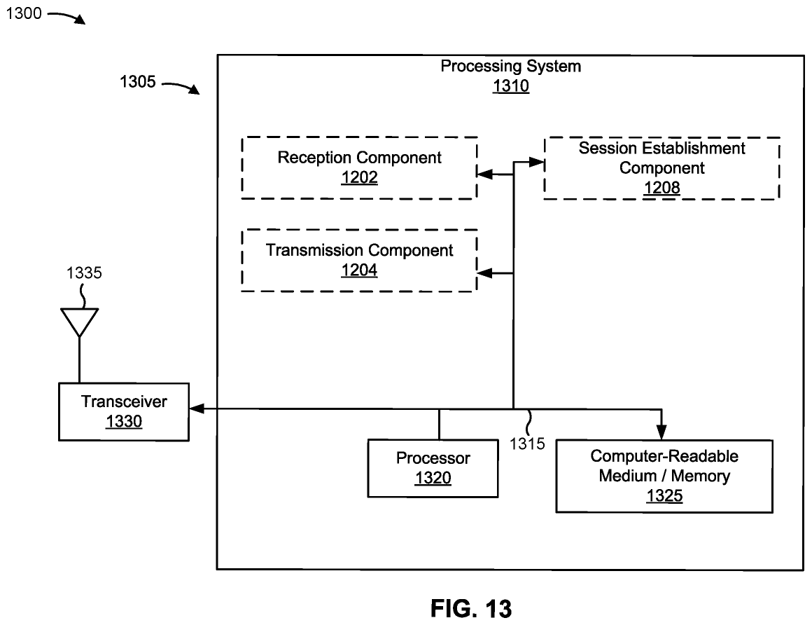

FIG. 13 is a diagram illustrating an example 1300 of a hardware implementation for an apparatus 1305 employing a processing system 1310. The apparatus 1305 may be a first network entity.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 may be coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information. In some examples, the apparatus 1305 may include an interface for communication with one or more network nodes, such as via a backhaul, midhaul, or fronthaul link. In some aspects, the interface may include the transceiver 1330 and/or the one or more antennas 1335. In some other aspects, the apparatus 1305 may not include the transceiver 1330 and/or the one or more antennas 1335.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the base station 110 and may include the memory 242 and/or at least one of the TX MIMO processor 230, the RX processor 238, and/or the controller/processor 240. In some aspects, the processing system 1310 may be a component of a CU. In some aspects, the processing system 1310 may be a component of a DU. In some aspects, the processing system 1310 may be a component of an RU. In some aspects, the processing system 1310 may be one or more components of a 5G system, such as shown in FIGS. 3 and 4, and may include a memory and one or more processors. In some aspects, the apparatus 1305 for wireless communication includes means for identifying a PDU session with a UE; means for obtaining configuration information associated with a first service provider, wherein the first network entity is associated with a standalone non-public network provided by a second service; and means for transmitting the configuration information to the UE or to a second network entity associated with the standalone non-public network. The aforementioned means may be one or more of the aforementioned components of the apparatus 1200 and/or the processing system 1310 of the apparatus 1305 configured to perform the functions recited by the aforementioned means. As in some aspects, described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 13 is provided as an example. Other examples may differ from what is described in connection with FIG. 13.

FIG. 14 is a block diagram of an example apparatus 1400 for wireless communication. The apparatus 1400 may be a first network entity (e.g., UDM 325, UDM 410, AMF 305, the AMF of FIG. 4), or a first network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a determination component 1408, among other examples.

In some aspects, the apparatus 1400 may be configured to perform one or more operations described herein in connection with FIGS. 3-8. Additionally, or alternatively, the apparatus 1400 may be configured to perform one or more processes described herein, such as method 1000 of FIG. 10, or a combination thereof. In some aspects, the apparatus 1400 and/or one or more components shown in FIG. 14 may include one or more components of the first network entity described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the first network entity described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the first network entity described above in connection with FIG. 2. In some aspects, the transmission component 1404 may be co-located with the reception component 1402 in a transceiver.

The reception component 1402 may receive, from a second network entity, a request for configuration information associated with a first service provider, wherein the first network entity and the second network entity are associated with a standalone non-public network provided by a second service provider, and wherein the configuration information relates to a UE associated with the first service provider accessing the standalone non-public network. The reception component 1402 may obtain the configuration information from a proxy entity associated with the standalone non-public network based at least in part on the request for the configuration information. The transmission component 1404 may transmit the configuration information to the second network entity.

The determination component 1408 may determine that the configuration information is to be obtained from the proxy entity based at least in part on the request for the configuration information or based at least in part on a configuration of the first network entity.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

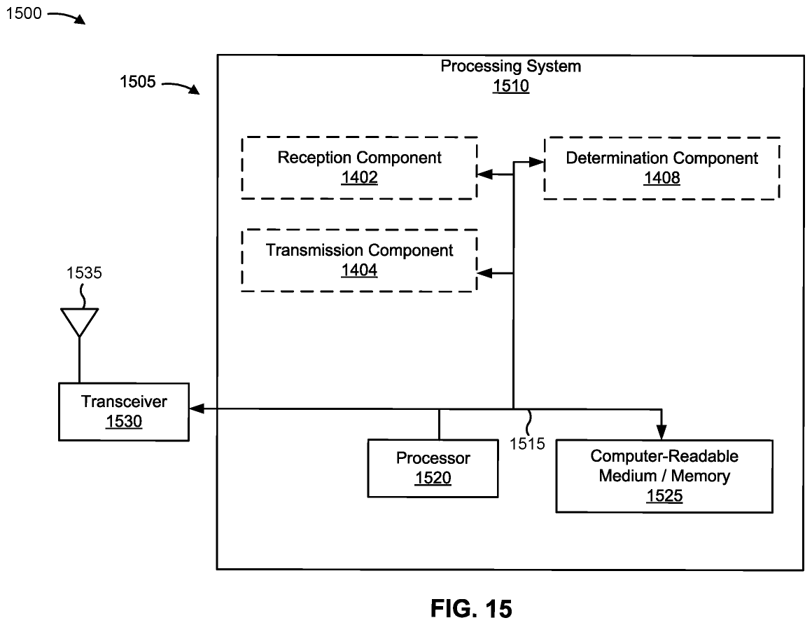

FIG. 15 is a diagram illustrating an example 1500 of a hardware implementation for an apparatus 1505 employing a processing system 1510. The apparatus 1505 may be a first network entity.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor 1520, the illustrated components, and the computer-readable medium/memory 1525. The bus 1515 may also link various other circuits, such as timing sources, peripherals, voltage regulators, and/or power management circuits.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the base station 110 and may include the memory 242 and/or at least one of the TX MIMO processor 230, the RX processor 238, and/or the controller/processor 240. In some aspects, the processing system 1510 may be one or more components of a 5G system, such as shown in FIGS. 3 and 4, and may include a memory and one or more processors. In some aspects, the apparatus 1505 for wireless communication includes means for receiving, from a second network entity, a request for configuration information associated with a first service provider, wherein the first network entity and the second network entity are associated with a standalone non-public network provided by a second service provider; means for obtaining the configuration information from a proxy entity associated with the standalone non-public network based at least in part on the request for the configuration information; and means for transmitting the configuration information to the second network entity. The aforementioned means may be one or more of the aforementioned components of the apparatus 1400 and/or the processing system 1510 of the apparatus 1505 configured to perform the functions recited by the aforementioned means. As in some aspects, described elsewhere herein, the processing system 1510 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 15 is provided as an example Other examples may differ from what is described in connection with FIG. 15.

FIG. 16 is a block diagram of an example apparatus 1600 for wireless communication. The apparatus 1600 may be a first network entity, or a first network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a communication component 1608, among other examples.

In some aspects, the apparatus 1600 may be configured to perform one or more operations described herein in connection with FIGS. 3-8. Additionally, or alternatively, the apparatus 1600 may be configured to perform one or more processes described herein, such as method 1100 of FIG. 11, or a combination thereof. In some aspects, the apparatus 1600 and/or one or more components shown in FIG. 16 may include one or more components of the first network entity described above in connection with FIG. 2. Additionally, or alternatively, one or more components shown in FIG. 16 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a demodulator, a MIMO detector, a receive processor, a controller/processor, a memory, or a combination thereof, of the first network entity described above in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modulator, a transmit MIMO processor, a transmit processor, a controller/processor, a memory, or a combination thereof, of the first network entity described above in connection with FIG. 2. In some aspects, the transmission component 1604 may be co-located with the reception component 1602 in a transceiver.

The reception component 1602 or the communication component 1608 may receive, from a network entity associated with a first service provider, configuration information relating to a UE accessing a standalone non-public network associated with the first network entity, wherein the standalone non-public network is associated with a second service provider. For example, the communication component 1608 may handle communication with the network entity associated with the first service provider. The reception component 1602 may receive, from a second network entity associated with the standalone non-public network, a request for at least part of the configuration information. The transmission component 1604 may transmit the configuration information to the second network entity based at least in part on the request.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

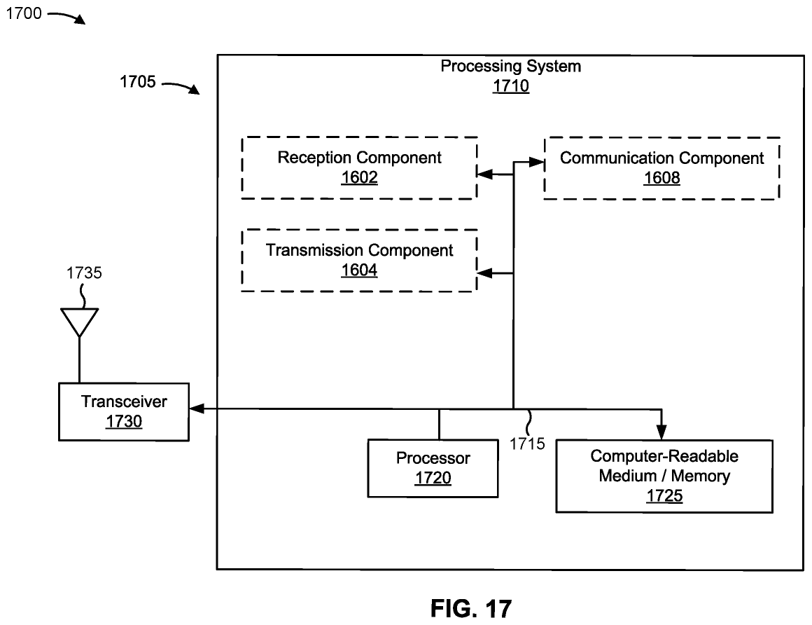

FIG. 17 is a diagram illustrating an example 1700 of a hardware implementation for an apparatus 1705 employing a processing system 1710. The apparatus 1705 may be a first network entity.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the RX processor 238, and/or the controller/processor 240. In some aspects, the processing system 1710 may be one or more components of a 5G system, such as shown in FIGS. 3 and 4, and may include a memory and one or more processors. In some aspects, the apparatus 1705 for wireless communication includes means for receiving, from a network entity associated with a first service provider, configuration information relating to a UE visiting a standalone non-public network associated with the first network entity; means for receiving, from a second network entity associated with the standalone non-public network, a request for at least part of the configuration information; and means for transmitting the configuration information to the second network entity based at least in part on the request. The aforementioned means may be one or more of the aforementioned components of the apparatus 1600 and/or the processing system 1710 of the apparatus 1705 configured to perform the functions recited by the aforementioned means. As in some aspects, described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

The following provides an overview of some Aspects of the present disclosure:

Aspect 1: A method of wireless communication performed by a first network entity, comprising: identifying a protocol data unit (PDU) session with a user equipment (UE); obtaining, based at least in part on identifying the PDU session, configuration information associated with a first service provider, wherein the first network entity is associated with a standalone non-public network provided by a second service provider; and transmitting the configuration information to the UE or to a second network entity associated with the standalone non-public network.

Aspect 2: The method of Aspect 1, wherein obtaining the configuration information further comprises: requesting, from a third network entity associated with the standalone non-public network, a subscription indicating to request the configuration information, wherein the third network entity is a unified data management function; and requesting the configuration information based at least in part on the subscription.

Aspect 3: The method of Aspect 2, wherein requesting the subscription indicating to request the configuration information is based at least in part on successful authentication of the UE.

Aspect 4: The method of Aspect 1, wherein obtaining the configuration information further comprises: obtaining the configuration information from a network entity associated with the first service provider.

Aspect 5: The method of Aspect 4, wherein the network entity associated with the first service provider is an authentication, authorization, and accounting server, and wherein the configuration information is obtained via one or more third network entities associated with the standalone non-public network.

Aspect 6: The method of Aspect 4, wherein the network entity associated with the first service provider is a unified data management function of a network associated with the first service provider.

Aspect 7: The method of any of Aspects 1-6, wherein transmitting the configuration information to the UE further comprises: transmitting the configuration information to the UE in a protocol configuration options component of a message.

Aspect 8: The method of any of Aspects 1-7, wherein the configuration information transmitted to the UE includes a proxy call session control function address for a proxy call session control function associated with the first service provider.

Aspect 9: The method of any of Aspects 1-8, wherein the configuration information transmitted to the second network entity includes a tunnel configuration for a tunnel between the second network entity and a network associated with the first service provider, and wherein the second network entity is a user plane function associated with the UE.

Aspect 10: The method of Aspect 9, wherein the tunnel configuration indicates whether the tunnel is a shared tunnel or a dedicated tunnel.

Aspect 11: The method of any of Aspects 1-10, wherein the configuration information is obtained from an access and mobility management function.

Aspect 12: A method of wireless communication performed by a first network entity, comprising: receiving, from a second network entity, a request for configuration information associated with a first service provider, wherein the first network entity and the second network entity are associated with a standalone non-public network provided by a second service provider, and wherein the configuration information relates to a user equipment (UE) associated with the first service provider accessing the standalone non-public network; obtaining the configuration information from a proxy entity associated with the standalone non-public network based at least in part on the request for the configuration information; and transmitting the configuration information to the second network entity.

Aspect 13: The method of Aspect 12, wherein the request is received based at least in part on a protocol data unit (PDU) session being established between the UE and the second network entity.

Aspect 14: The method of any of Aspects 12-12, further comprising: determining that the configuration information is to be obtained from the proxy entity based at least in part on the request for the configuration information or based at least in part on a configuration of the first network entity.

Aspect 15: The method of Aspect 14, wherein obtaining the configuration information further comprises: requesting the configuration information from the proxy entity, wherein the configuration information is available to the proxy entity based at least in part on authentication of the UE with regard to the standalone non-public network, and wherein the configuration information relates to network slice selection assistance information or to a data network name associated with the network slice selection assistance information.

Aspect 16: The method of any of Aspects 12-15, wherein the configuration information is transmitted to the second network entity as part of subscription information associated with the second network entity.

Aspect 17: The method of any of Aspects 12-16, wherein the first network entity is a unified data management function, and wherein the second network entity is a session management function.

Aspect 18: The method of any of Aspects 12-17, wherein the configuration information includes a proxy call session control function address for a proxy call session control function associated with the first service provider.

Aspect 19: The method of any of Aspects 12-18, wherein the configuration information includes a tunnel configuration for a tunnel between the second network entity and a network associated with the first service provider.

Aspect 20: A method of wireless communication performed by a first network entity, comprising: receiving, from a network entity associated with a first service provider, configuration information relating to a user equipment (UE) accessing a standalone non-public network associated with the first network entity, wherein the standalone non-public network is associated with a second service provider; receiving, from a second network entity associated with the standalone non-public network, a request for at least part of the configuration information; and transmitting the configuration information to the second network entity based at least in part on the request.

Aspect 21: The method of Aspect 20, wherein receiving the configuration information is based at least in part on the UE being authenticated on the standalone non-public network.

Aspect 22: The method of any of Aspects 20-21, wherein the configuration information includes at least one of: a proxy call session control function (P-CSCF) address for a P-CSCF associated with the first service provider, network slice selection assistance information associated with the first service provider, or a data network name associated with the first service provider.

Aspect 23: The method of Aspects 20-22, wherein the configuration information includes a tunnel configuration for a tunnel between the second network entity and a network associated with the first service provider, wherein the tunnel configuration includes at least one of: a data network name associated with the first service provider, network slice selection assistance information associated with the first service provider, a tunneling type associated with a tunnel, a tunnel server address associated with the tunnel, a credential associated with the tunnel, or an indication of whether the tunnel is a shared tunnel or a dedicated tunnel.

Aspect 24: The method of any of Aspects 20-23, wherein the first network entity is an authentication server function and the second network entity is an access and mobility management function or a unified data management function.

Aspect 25: A method of wireless communication performed by a first network entity, comprising: identifying a protocol data unit (PDU) session with a user equipment (UE); obtaining, based at least in part on identifying the PDU session, configuration information associated with a first data network provider, wherein the first network entity is associated with a first network provided by a second data network provider, wherein the configuration information includes a tunnel configuration for a tunnel between a second network entity associated with the first network and a second network associated with the first data network provider; and transmitting the configuration information to the UE or to the second network entity associated with the first network.

Aspect 26: The method of Aspect 25, wherein the first network is a standalone non-public network.

Aspect 27: The method of any of Aspects 25-26, wherein obtaining the configuration information further comprises: requesting, from a third network entity associated with the first network, a subscription indicating to request the configuration information; and requesting the configuration information based at least in part on the subscription.

Aspect 28: The method of any of Aspects 25-27, wherein requesting the subscription indicating to request the configuration information is based at least in part on successful authentication of the UE.

Aspect 29: The method of any of Aspects 25-28, wherein obtaining the configuration information further comprises: obtaining the configuration information from a network entity associated with the first data network provider.

Aspect 30: The method of Aspect 29, wherein the network entity associated with the first data network provider is an authentication, authorization, and accounting server.

Aspect 31: The method of Aspect 29, wherein the network entity associated with the first data network provider is a unified data management function of a network associated with the first data network provider.

Aspect 32: The method of any of Aspects 25-31, wherein transmitting the configuration information to the UE further comprises: transmitting the configuration information to the UE in a protocol configuration options component of a message.

Aspect 33: The method of any of Aspects 25-32, wherein the tunnel configuration indicates whether the tunnel is a shared tunnel or a dedicated tunnel.

Aspect 34: The method of any of Aspects 25-33, wherein the configuration information is obtained from an access and mobility management function.

Aspect 35: The method of any of Aspects 25-34, wherein the tunnel is associated with enabling the UE to access a service provided by an Internet Protocol media subsystem of the first data network provider.

Aspect 36: The method of any of Aspects 25-35, wherein the tunnel configuration indicates at least a tunnel server address or one or more credentials for the tunnel.

Aspect 37: The method of any of Aspects 25-36, wherein the tunnel is associated with a Layer 2 tunneling protocol or an Internet Protocol security protocol.

Aspect 38: An apparatus for wireless communication at a device, comprising a processor; memory coupled with the processor; and instructions stored in the memory and executable by the processor to cause the apparatus to perform the method of one or more Aspects of Aspects 1-37.

Aspect 39: A network entity for wireless communication, comprising a memory and one or more processors coupled to the memory, the one or more processors configured to perform the method of one or more Aspects of Aspects 1-37.

Aspect 40: An apparatus for wireless communication, comprising at least one means for performing the method of one or more Aspects of Aspects 1-37.

Aspect 41: A non-transitory computer-readable medium storing code for wireless communication, the code comprising instructions executable by a processor to perform the method of one or more Aspects of Aspects 1-37.

Aspect 42: A non-transitory computer-readable medium storing a set of instructions for wireless communication, the set of instructions comprising one or more instructions that, when executed by one or more processors of a device, cause the device to perform the method of one or more Aspects of Aspects 1-37.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network entity for wireless communication, comprising:
a memory; and
one or more processors, coupled to the memory, configured to:
identify a protocol data unit (PDU) session with a user equipment (UE);
obtain, based at least in part on identifying the PDU session, configuration information associated with a first data network provider, wherein the first network entity is associated with a first network provided by a second data network provider, wherein the configuration information includes a tunnel configuration for a tunnel between a second network entity associated with the first network and a second network associated with the first data network provider; and
transmit the configuration information to the UE or to the second network entity associated with the first network.

2. The first network entity of claim 1, wherein the first network is a standalone non-public network.

3. The first network entity of claim 1, wherein the one or more processors, to obtain the configuration information, are configured to:
request, from a third network entity associated with the first network, a subscription indicating to request the configuration information; and
request the configuration information based at least in part on the subscription.

4. The first network entity of claim 3, wherein requesting the subscription indicating to request the configuration information is based at least in part on successful authentication of the UE.

5. The first network entity of claim 1, wherein the one or more processors, to obtain the configuration information, are configured to:
obtain the configuration information from a network entity associated with the first data network provider.

6. The first network entity of claim 5, wherein the network entity associated with the first data network provider is an authentication, authorization, and accounting server.

7. The first network entity of claim 5, wherein the network entity associated with the first data network provider is a unified data management function of a network associated with the first data network provider.

8. The first network entity of claim 1, wherein the one or more processors, to transmit the configuration information to the UE, are configured to:
transmit the configuration information to the UE in a protocol configuration options component of a message.

9. The first network entity of claim 1, wherein the tunnel configuration indicates whether the tunnel is a shared tunnel or a dedicated tunnel.

10. The first network entity of claim 1, wherein the configuration information is obtained from an access and mobility management function.

11. The first network entity of claim 1, wherein the tunnel is associated with enabling the UE to access a service provided by an Internet Protocol media subsystem of the first data network provider.

12. The first network entity of claim 1, wherein the tunnel configuration indicates at least a tunnel server address or one or more credentials for the tunnel.

13. The first network entity of claim 1, wherein the tunnel is associated with a Layer 2 tunneling protocol or an Internet Protocol security protocol.

14. A method of wireless communication performed by a first network entity, comprising:
identifying a protocol data unit (PDU) session with a user equipment (UE);
obtaining, based at least in part on identifying the PDU session, configuration information associated with a first data network provider, wherein the first network entity is associated with a first network provided by a second data network provider, wherein the configuration information includes a tunnel configuration for a tunnel between a second network entity associated with the first network and a second network associated with the first data network provider; and
transmitting the configuration information to the UE or to the second network entity associated with the first network.

15. The method of claim 14, wherein the first network is a standalone non-public network.

16. The method of claim 14, wherein obtaining the configuration information further comprises:
requesting, from a third network entity associated with the first network, a subscription indicating to request the configuration information; and
requesting the configuration information based at least in part on the subscription.

17. The method of claim 16, wherein requesting the subscription indicating to request the configuration information is based at least in part on successful authentication of the UE.

18. The method of claim 14, wherein obtaining the configuration information further comprises:
obtaining the configuration information from a network entity associated with the first data network provider.

19. The method of claim 18, wherein the network entity associated with the first data network provider is an authentication, authorization, and accounting server.

20. The method of claim 18, wherein the network entity associated with the first data network provider is a unified data management function of a network associated with the first data network provider.

21. The method of claim 14, wherein transmitting the configuration information to the UE further comprises:
transmitting the configuration information to the UE in a protocol configuration options component of a message.

22. The method of claim 14, wherein the tunnel configuration indicates whether the tunnel is a shared tunnel or a dedicated tunnel.

23. The method of claim 14, wherein the configuration information is obtained from an access and mobility management function.

24. The method of claim 14, wherein the tunnel is associated with enabling the UE to access a service provided by an Internet Protocol media subsystem of the first data network provider.

25. The method of claim 14, wherein the tunnel configuration indicates at least a tunnel server address or one or more credentials for the tunnel.

26. The method of claim 14, wherein the tunnel is associated with a Layer 2 tunneling protocol or an Internet Protocol security protocol.

27. A non-transitory computer-readable medium storing a set of instructions for wireless communication, the set of instructions comprising:
one or more instructions that, when executed by one or more processors of a first network entity, cause the first network entity to:
identify a protocol data unit (PDU) session with a user equipment (UE);
obtain, based at least in part on identifying the PDU session, configuration information associated with a first data network provider, wherein the first network entity is associated with a first network provided by a second data network provider, wherein the configuration information includes a tunnel configuration for a tunnel between a second network entity associated with the first network and a second network associated with the first data network provider; and
transmit the configuration information to the UE or to the second network entity associated with the first network.

28. The non-transitory computer-readable medium of claim 27, wherein the first network is a standalone non-public network.

29. An apparatus for wireless communication, comprising:
means for identifying a protocol data unit (PDU) session with a user equipment (UE);
means for obtaining, based at least in part on identifying the PDU session, configuration information associated with a first data network provider, wherein the apparatus is associated with a first network provided by a second data network provider, wherein the configuration information includes a tunnel configuration for a tunnel between a second network entity associated with the first network and a second network associated with the first data network provider; and
means for transmitting the configuration information to the UE or to the second network entity associated with the first network.

30. The apparatus of claim 29, wherein the first network is a standalone non-public network.
